(19) United States
(12) Patent Application Publication
(10) Pub. No.: US 2024/0241948 A1
(43) Pub. Date: Jul. 18, 2024

(54) PREVENTING INSIDER THREAT UTILIZING MACHINE LEARNING

(71) Applicant: SAUDI ARABIAN OIL COMPANY, Dhahran (SA)

(72) Inventors: Rayan M. Hassanain, Dhahran (SA); Majed A. Hakami, Dhahran (SA)

(73) Assignee: SAUDI ARABIAN OIL COMPANY, Dhahran (SA)

(21) Appl. No.: 18/153,706

(22) Filed: Jan. 12, 2023

(51) Int. Cl. G06F 21/55; G06N 20/00

(52) U.S. Cl. CPC G06F 21/554; G06N 20/00; G06F 2221/034

(57) ABSTRACT

A method for mitigating insider threat to an organization is disclosed. The method includes retrieving, from a database stored on a computing system of the organization, Universal Serial Bus (USB) logs recording USB activities of users of the organization, generating, based on the USB logs and using a machine learning (ML) module of an insider threat mitigation system, a trained ML model, further retrieving, from the database and in response to generating the trained ML model, subsequent USB logs recording subsequent USB activities of the users, analyzing, based on the trained ML model and using the ML module, the subsequent USB logs to detect an abnormal user activity, and performing, in response to the detected abnormal user activity and using a revoke access module of the insider threat mitigation system, a mitigation task of the computer system.

### BACKGROUND

Throughout this disclosure, the term “organization” refers to an organized body of people with a particular purpose, such as a business, a society, an association, etc. An insider is any person who has or had authorized access to an organization's resources, including personnel, facilities, information, equipment, networks, and computer systems. Insider threat is the potential for an insider to use authorized access to harm the organization, such as malicious, complacent, or unintentional acts that negatively affect the integrity, confidentiality, and availability of the organization's resources, such as the data, personnel, or computer facilities of the organization.

A security incidence is an occurrence that actually or potentially jeopardizes the confidentiality, integrity, or availability of the organization's resources or that constitutes a violation or imminent threat of violation of security policies, security procedures, or acceptable use policies of the organization.

Universal Serial Bus (USB) is an industry standard that establishes connection and communication specification between computers, peripherals, and other computers. Examples of peripherals that are connected via USB include computer keyboards and mice, video cameras, printers, portable media players, mobile (portable) digital telephones, disk drives, and network adapters.

A USB flash drive (also referred to as a USB drive or a thumb drive) is a data storage device that includes flash memory with an integrated USB interface. It is typically removable, rewritable, and has a small size. Wide use of USB drives throughout organizations has created security challenges to mitigate insider threat. First, detecting and preventing data leakage can be difficult due to the small sizes, ease of concealment and ubiquity of the USB drives. In addition, it is also difficult to prevent a system compromise from malware, viruses and spyware carried on the USB drive itself.

Event Tracing for Windows (ETW) is a general-purpose, high-speed tracing facility that is provided by the operating system (OS). ETW provides an event logging mechanism for the USB driver stack to facilitate investigating, diagnosing, and debugging USB-related issues in a computer system. Based on the event logging mechanism, a record (referred to as a history log) may be maintained of every USB device that is connected to and unplugged from the computer having the ETW installed. The record may include a Windows security log event ID.

Endpoint Detection and Response (EDR), also referred to as endpoint detection and threat response (EDTR), is an endpoint security solution that continuously monitors end-user devices to detect and respond to cyber threats, such as ransomware and malware.

### SUMMARY

In general, in one aspect, the invention relates to a method for mitigating insider threat to an organization. The method includes retrieving, from a database stored on a computing system of the organization, Universal Serial Bus (USB) logs recording USB activities of users of the organization, generating, based on the USB logs and using a machine learning (ML) module of an insider threat mitigation system, a trained ML model, further retrieving, from the database and in response to generating the trained ML model, subsequent USB logs recording subsequent USB activities of the users, analyzing, based on the trained ML model and using the ML module, the subsequent USB logs to detect an abnormal user activity, and performing, in response to the detected abnormal user activity and using a revoke access module of the insider threat mitigation system, a mitigation task of the computer system.

In general, in one aspect, the invention relates to an insider threat mitigation system. The insider threat mitigation system includes a computer processor, and memory storing instructions executable by the computer processor to perform insider threat mitigation, the instructions include a machine learning (ML) module configured to retrieve, from a database stored on a computing system of an organization, USB logs recording USB activities of users of the organization, generate, based on the USB logs, a trained ML model, further retrieve, from the database and in response to generating the trained ML model, subsequent USB logs recording subsequent USB activities of the users, and analyze, based on the trained ML model, the subsequent USB logs to detect an abnormal user activity, and a revoke access module configured to perform, in response to the detected abnormal user activity and using, a mitigation task of the computer system.

In general, in one aspect, the invention relates to a system that includes a computing system of an organization, and an insider threat mitigation system including a machine learning (ML) module configured to retrieve, from a database stored on a computing system of an organization, USB logs recording USB activities of users of the organization, generate, based on the USB logs, a trained ML model, further retrieve, from the database and in response to generating the trained ML model, subsequent USB logs recording subsequent USB activities of the users, and analyze, based on the trained ML model, the subsequent USB logs to detect an abnormal user activity, and a revoke access module configured to perform, in response to the detected abnormal user activity and using, a mitigation task of the computer system.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1B and 2 show systems in accordance with one or more embodiments.

FIG. 3 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein include a method, an apparatus, and a system to prevent insider threat by utilizing machine learning techniques based on USB activity logs of a computer system. In particular, an insider threat mitigation workflow is performed using an insider threat mitigation system to mitigate insider threats to an organization's resources. In one or more embodiments of the invention, the insider threat mitigation system includes a machine learning (ML) module, a revoke access module, and a reporting module. During on-going activities of an organization's resources, all USB activities in the organization's computer facilities are logged in one or more databases, e.g., managed by an OS or other log management solutions executing on the computer facilities. To perform the insider threat mitigation workflow, all USB activity logs in the organization's computer facilities are parsed by the ML module and used to train a machine learning algorithm to generate a baseline data record representing a baseline behavior for normal user activities within the organization. The baseline data record is part of a trained ML model. Once the baseline data record is generated, new USB activity logs from all logging databases are retrieved to be analyzed by the ML module based on the trained ML model in order to detect any abnormal user activities. In one or more embodiments, the ML model is further trained based on verified historical security incidences, such as data leak, ransomware, malware, etc. The detected abnormal user activities are sent from the ML module to a revoke access module that performs a mitigation task, such as revoking any user account associated with the abnormal user activities. Accordingly, the reporting module reports the result of the mitigation task to an incident response team of the organization for further analysis. For example, the reporting module may report the mitigation task results using emails, texts, or any alert system of the organization.

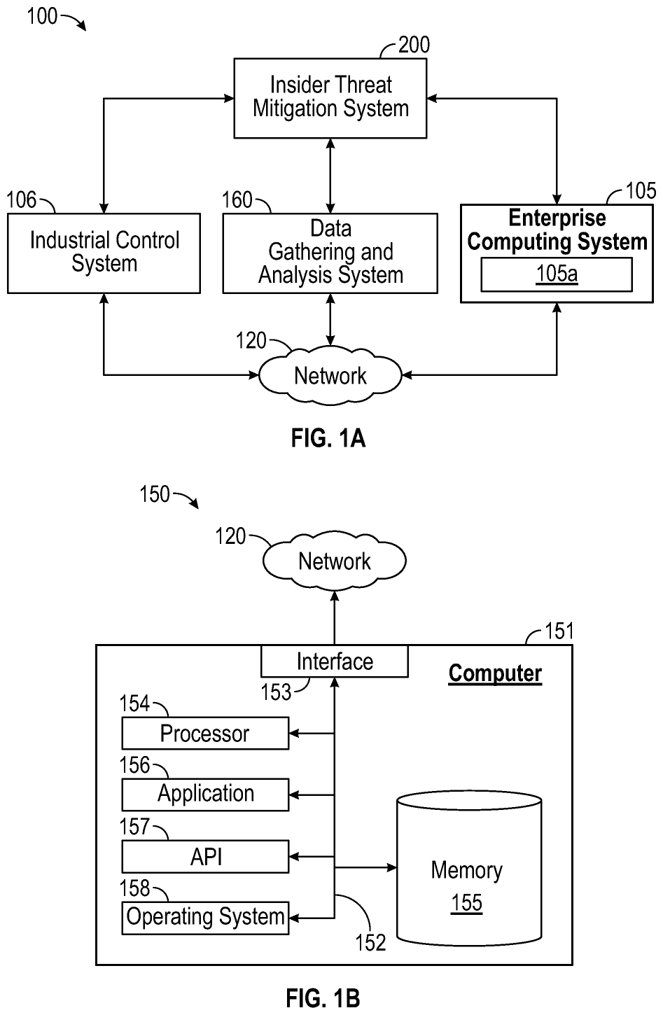

FIGS. 1A-1B show a schematic diagram of an organization's computing facilities in accordance with one or more embodiments. In one or more embodiments, one or more of the modules and/or elements shown in FIGS. 1A-1B may be omitted, repeated, and/or substituted. Accordingly, embodiments disclosed herein should not be considered limited to the specific arrangements of modules and/or elements shown in FIGS. 1A-1B.

As shown in FIG. 1A, the organization's computing facility (100) include an enterprise computing system (105), an industrial control system (106), and a data gathering and analysis system (160).

In some embodiments, the enterprise computing system (105) includes hardware and/or software with functionality for facilitating general operations of the organization, such as business operations and management reporting operations. Examples of such operations include customer relationship management, enterprise resource planning, supply chain management, etc.

In some embodiments, the industrial control system (106) includes hardware and/or software with functionality for facilitating industrial control operations of the organization, in particular when the organization is or includes a production company. Generally, the industrial control system (106) includes different types of control systems and associated instrumentation, devices, systems, networks, and controls used to operate and/or automate industrial processes. Examples of the industrial control system (106) include Supervisory Control and Data Acquisition (SCADA) systems and Distributed Control Systems (DCS).

In some embodiments, the data gathering and analysis system (160) includes hardware and/or software with functionality for facilitating operations of the enterprise computing system (105) and the industrial control system (106). For example, the data gathering and analysis system (160) may retrieve and analyze business data, industrial process data, and various sensor data to facilitate the business operations, management reporting operations, and industrial processes.

In some embodiments, the enterprise computing system (105), the industrial control system (106), and the data gathering and analysis system (160) may include one or more computing devices similar to the computing device (150) described below with regard to FIGS. 1B and 1C and the accompanying description.

In some embodiments, one or more of the enterprise computing system (105), the industrial control system (106), and the data gathering and analysis system (160) are provided with USB interfaces and are susceptible to insider threat. For example, the enterprise computing system (105) includes at least one USB interface (105a). Further, the enterprise computing system (105), the industrial control system (106), and the data gathering and analysis system (160) are communicably coupled with each other via a computer network (120), such as an industrial control network, an enterprise network, the Internet, etc. Accordingly, all of the enterprise computing system (105), the industrial control system (106), and the data gathering and analysis system (160) are susceptible to the insider threat associated with any USB interface present anywhere in the organization. In other words, the business operations, management reporting operations, and industrial processes of the organization may be compromised by the insider threat associated with such USB interfaces. For example, USB devices may carry malware and spread infection as soon as they connect to a computing device. The malware may take over user input devices (e.g., keyboards) while running in the background without being recognized by the user. Data loss or leakage is another concern that may arise while utilizing insecure USB drives. Losing USB drives containing sensitive information disrupts the work process and may result in General Data Protection Regulation (GDPR) noncompliance. Compromised data can stifle an organization's growth and tarnish brand image. It may interfere with milestones, roadmaps, and corporate strategies, depending on the extent of the insider threat.

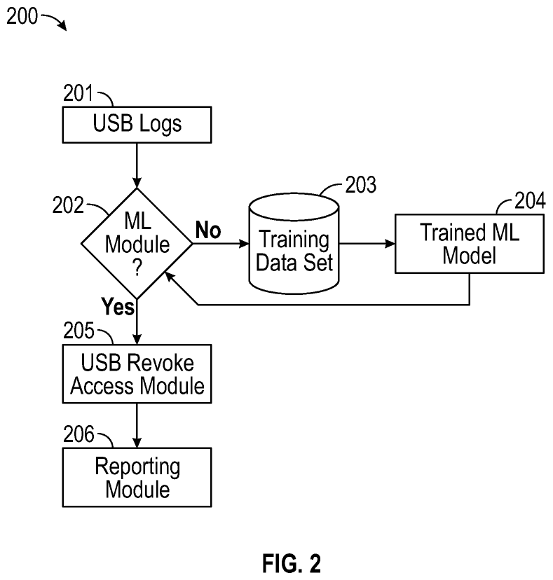

Accordingly, an insider threat mitigation system (200) is provided to mitigate the insider threat to the organization. In some embodiments, the insider threat mitigation system (200) is an apparatus separate from, but communicably coupled to, the enterprise computing system (105), the industrial control system (106), the data gathering and analysis system (160). In some embodiments, at least a portion of the insider threat mitigation system (200) is integrated in one or more of the enterprise computing system (105), the industrial control system (106), the data gathering and analysis system (160). Details of the insider threat mitigation system are described in reference to FIG. 2 below.

In some embodiments, the enterprise computing system (105), the industrial control system (106), the data gathering and analysis system (160), and the insider threat mitigation system (200) depicted in FIG. 1A above may be implemented on a computing system. FIG. 1B depicts a block diagram of a computing system (150) including a computer (151) used to provide computational functionalities associated with algorithms, methods, functions, processes, flows, and procedures as described in this disclosure, according to one or more embodiments. The illustrated computer (151) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (151) may include a computer that includes an input device, such as a keypad, keyboard, touch screen, USB drive, or other device that can accept user information, and an output device that conveys information associated with the operation of the computer (151), including digital data, visual, or audio information (or a combination of information), or a GUI.

The computer (151) can serve in a role as a client, network component, a server, a database or other persistency, or any other component (or a combination of roles) of a computer system for performing the subject matter described in the instant disclosure. The illustrated computer (151) is communicably coupled with a network (120). In some implementations, one or more components of the computer (151) may be configured to operate within environments, including cloud-computing-based, local, global, or other environment (or a combination of environments).

At a high level, the computer (151) is an electronic computing device operable to receive, transmit, process, store, or manage data and information associated with the described subject matter. According to some implementations, the computer (151) may also include or be communicably coupled with an application server, e-mail server, web server, caching server, streaming data server, business intelligence (BI) server, or other server (or a combination of servers).

The computer (151) can receive requests over network (120) from a client application (for example, executing on another computer (151)) and responding to the received requests by processing the said requests in an appropriate software application. In addition, requests may also be sent to the computer (151) from internal users (for example, from a command console or by other appropriate access method), external or third-parties, other automated applications, as well as any other appropriate entities, individuals, systems, or computers.

Each of the components of the computer (151) can communicate using a system bus (152). In some implementations, any or all of the components of the computer (151), both hardware or software (or a combination of hardware and software), may interface with each other or the interface (153) (or a combination of both) over the system bus (152) using an application programming interface (API) (157) or a service layer of an operating system (158) (or a combination of the API and service layer). The API (157) may include specifications for routines, data structures, and object classes. The API (157) may be either computer-language independent or dependent and refer to a complete interface, a single function, or even a set of APIs. The operating system (158) provides software services to the computer (151) or other components (whether or not illustrated) that are communicably coupled to the computer (151). The functionality of the computer (151) may be accessible for all service consumers using this service layer. Software services, such as those provided by the operating system (158), provide reusable, defined business functionalities through a defined interface. For example, the interface may be software written in JAVA, C++, or other suitable language providing data in extensible markup language (XML) format or another suitable format. While illustrated as an integrated component of the computer (151), alternative implementations may illustrate the API (157) or the operating system (158) as stand-alone components in relation to other components of the computer (151) or other components (whether or not illustrated) that are communicably coupled to the computer (151). Moreover, any or all parts of the API (157) or the service layer of the operating system (158) may be implemented as child or sub-modules of another software module, enterprise application, or hardware module without departing from the scope of this disclosure.

The computer (151) includes an interface (153). Although illustrated as a single interface (153) in FIG. 1B, two or more interfaces (153) may be used according to particular needs, desires, or particular implementations of the computer (151). The interface (153) is used by the computer (151) for communicating with other systems in a distributed environment that are connected to the network (120). Generally, the interface (153) includes logic encoded in software or hardware (or a combination of software and hardware) and operable to communicate with the network (120).

The computer (151) includes at least one computer processor (154). Although illustrated as a single computer processor (154) in FIG. 1B, two or more processors may be used according to particular needs, desires, or particular implementations of the computer (151). Generally, the computer processor (154) executes instructions and manipulates data to perform the operations of the computer (151) and any algorithms, methods, functions, processes, flows, and procedures as described in the instant disclosure.

The computer (151) also includes a memory (155) that holds data for the computer (151) or other components (or a combination of both) that can be connected to the network (120). For example, memory (155) can be a database storing data consistent with this disclosure. A database is a collection of information configured for ease of data retrieval, modification, re-organization, and deletion. Database Management System (DBMS) is a software application that provides an interface for users to define, create, query, update, or administer databases. Although illustrated as a single memory (155) in FIG. 1B, two or more memories may be used according to particular needs, desires, or particular implementations of the computer (151) and the described functionality. While memory (155) is illustrated as an integral component of the computer (151), in alternative implementations, memory (155) can be external to the computer (151).

The application (156) is an algorithmic software engine providing functionality according to particular needs, desires, or particular implementations of the computer (151), particularly with respect to functionality described in this disclosure. For example, application (156) can serve as one or more components, modules, applications, etc. Further, although illustrated as a single application (156), the application (156) may be implemented as multiple applications (156) on the computer (151). In addition, although illustrated as integral to the computer (151), in alternative implementations, the application (156) can be external to the computer (151).

There may be any number of computers (151) associated with, or external to, a computer system containing a computer (151), wherein each computer (151) communicates over network (120). Further, the term “client,” “user,” and other appropriate terminology may be used interchangeably as appropriate without departing from the scope of this disclosure. Moreover, this disclosure contemplates that many users may use one computer (151), or that one user may use multiple computers (151).

The above description of functions presents only a few examples of functions performed by the computing system of FIG. 1B. Other functions may be performed using one or more embodiments of the disclosure.

FIG. 2 shows a schematic diagram of the insider threat mitigation system (200) of FIG. 1A in accordance with one or more embodiments. In one or more embodiments, one or more of the modules and/or elements shown in FIG. 2 may be omitted, repeated, and/or substituted. Accordingly, embodiments disclosed herein should not be considered limited to the specific arrangements of modules and/or elements shown in FIG. 2.

As shown in FIG. 2, the insider threat mitigation system (200) includes USB logs (201), an ML module (202), a training data set (203), a trained ML model (204), an USB revoke access module (205), and a reporting module (206). In one or more embodiments, each of the ML module (202), the USB revoke access module (205), and the reporting module (206) includes hardware and/or software with functionality for performing operations of the insider threat mitigation system (200) of the organization's computer facility depicted in FIG. 1A above. In particular, each of the ML module (202), the USB revoke access module (205), and the reporting module (206) may correspond to a portion of the application (156) depicted in FIG. 1B above.

The USB logs (201) are data logs of all USB activities (i.e., data communications and/or data transactions associated with any USB interface, also referred to as USB activity logs) in the organization's computer facilities during on-going operations of the organization. For example, all USB activities in the organization's computer facilities are logged in one or more databases (e.g., implemented in the memory (155) depicted in FIG. 1B above) that are managed by an operating system mechanism (e.g., the Event Tracing for Windows (ETW) mechanism) or other log management solutions (e.g., an Endpoint Detection and Response (EDR) tool) executing on the computer facilities. For example, the ETW mechanism and the EDR tool may be provided by the operating system (158) and application (156), respectively as depicted in FIG. 1B above. The USB logs (201) are retrieved and parsed by the ML module (202) periodically or constantly to generate a training data set (203). TABLE 1 below lists seven example data fields or attributes that are included in the parsed output to represent the baseline behavior and form the training data set (203). For example, the example data fields include Windows security log event IDs 6416, 4688, 4664, 4656, 4658, and other relevant information.

The training data set (203) includes baseline data records representing a baseline behavior for normal user activities of all USB interfaces within the organization. The training data set (203) may further include logged data records of verified historical security incidences (e.g., verified data leaks, ransomware or malware attacks, etc.) for generating the trained ML model (204). For example, the training data set (203) may be stored in the memory (155) depicted in FIG. 1B above. In one or more embodiments, the trained ML model (204) is a machine learning model generated by the ML module (202) using a semi-supervised machine learning algorithm, such as support vector machine (SVM) algorithm. Semi-supervised machine learning algorithm is a combination of supervised and unsupervised learning algorithms. It uses a small amount of labeled data and a large amount of unlabeled data, which provides the benefits of both unsupervised and supervised learning while avoiding the challenges of finding a large amount of labeled data. For example, a portion of the USB logs (201) may be tagged with the verified historical security incidence data records to form the labeled data while a remaining portion of the USB logs (201) may not being tagged with incidence data records. The labeled data is tagged as abnormal (i.e., malicious) or normal (i.e., non-malicious). The unlabeled data may be tagged with a pseudo label by the SVM algorithm.

```
TABLE 1
1- Time
  During working hours, or after working hours.
2- USB Vendor ID event ID 6416
  Every USB has a specific id, and some ids are known to be malicious.
3- Size of data moved to the USB.
  This indicates data leakage
4- Windows event ID 4688
  This event ID shows when a USB device is connected.
5- Windows event IDs 4663, 4656
  These event IDs log successful and failed attempts to write to or read
    from a removable USB storage device.
6- Windows event ID 4658
  This event ID logs when a handle to an object is closed.
7- EDR logs in terms of processes depending on the EDR solution, and their logs.
```

In one or more embodiments, the ML module (202) is configured to generate different outputs based on a decision made using the trained ML model (204). All new USB activity logs from all logging databases are retrieved periodically and analyzed by the ML module (202) based on the trained ML model (204) in order to detect any abnormal user activities. For example, the new USB activity logs within a pre-determined rolling time window (e.g., one minute, 15 minutes, etc.) are retrieved on a periodic basis, such as every minute, every 15 minutes, etc. If it is determined based on the trained ML model (204) that the newly retrieved USB activity logs do not correspond to any abnormal user activities, the newly retrieved USB activity logs are added to augment the training data set (203) and update the trained ML model (204). This decision and corresponding output are shown as the horizontal arrow annotated with “N” in FIG. 2. In contrast, if it is determined based on the trained ML model (204) that the newly retrieved USB activity logs do correspond to abnormal user activities, an alert is generated and the newly retrieved USB activity logs and corresponding detected abnormal user activities are sent from the ML module (202) to the revoke access module (205). This decision and corresponding output are shown as the vertical arrow annotated with “Y” in FIG. 2.

In one or more embodiments, the revoke access module (205) is configured to perform, in response to the detected abnormal user activities sent from the ML module (202), a mitigation task of the organization's computer facilities, such as revoking the USB accesses of any user account associated with the abnormal user activities.

In one or more embodiments, the reporting module (205) is configured to report, in response to the mitigation task performed by the revoke access module (205), the result of the mitigation task. For example, the result may be reported, using emails, texts, or any alert system of the organization, to an incident response team of the organization for further analysis. The USB access of the user account associated with the abnormal user activities are revoked as soon as the ML module (202) generates the alert. The incident response team will then check the reported detection of abnormal user activities, and give access back to the user if the activity is re-qualified or otherwise determined by the incident response team as benign.

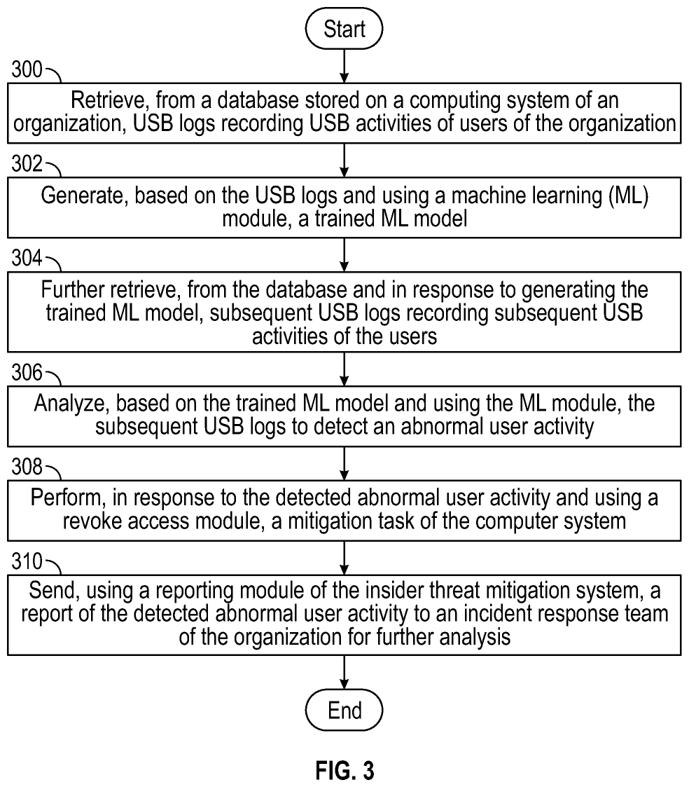

FIG. 3 shows a flowchart in accordance with one or more embodiments disclosed herein. One or more of the steps in FIG. 3 may be performed by the components of the insider threat mitigation system discussed above in reference to FIGS. 1A-1B and 2. In one or more embodiments, one or more of the steps shown in FIG. 3 may be omitted, repeated, and/or performed in a different order than the order shown in FIG. 3. Accordingly, the scope of the disclosure should not be considered limited to the specific arrangement of steps shown in FIG. 3.

The flowchart depicted in FIG. 3 illustrate a method for preventing the intentional or unintentional insider threats by training a semi-supervised machine learning algorithm from the OS event logs to establish a baseline for users' USB access activities within an organization. By establishing the baseline, abnormal and malicious USB activities related to the insider threat attack are detected and mitigated.

Referring to FIG. 3, initially in Step 300, USB logs are retrieved from a database stored on a computing system of the organization. The USB logs record USB activities of users of the organization. In some embodiments, verified historical security incidence data records of the organization are also retrieved. For example, the USB logs may be generated by an Event Tracing for Windows (ETW) mechanism executing on the computer system and stored in the database. Similarly, the verified historical security incidence data records may be generated by an Endpoint Detection and Response (EDR) tool executing on the computer system and stored in the database.

In Step 302, a trained machine learning (ML) model is generated based on the USB logs using an ML algorithm. To generate the ML model, a training data set is first generated based on the USB logs and the verified historical security incidence data records. In some embodiments, labeled training data of the training data set is generated based on a portion of the USB logs that are correlated with the verified historical security incidence data records. In addition, unlabeled training data of the training data set is generated based on a remaining portion of the USB logs that are not correlated with the verified historical security incidence data records. In some embodiments, the ML algorithm is a semi-supervised machine learning algorithm.

In Step 304, subsequent to generating the trained ML model, additional USB logs (referred to as subsequent USB logs) that record subsequent USB activities of the users are retrieved from the database.

In Step 306, the subsequent USB logs are analyzed based on the trained ML model and using the ML algorithm to detect an abnormal user activity.

In Step 308, in response to the detected abnormal user activity, a mitigation task of the computer system is performed. In some embodiments, the mitigation task includes revoking USB access of a user account associated with the detected abnormal user activity.

In Step 310, a report of the detected abnormal user activity is sent to an incident response team of the organization for further analysis. For example, the incident response team may perform a detail investigation to confirm if the detected abnormal user activity corresponds to a real security incidence or a false alarm. The incident response team may reactivate the USB access of the user account if the detected abnormal user activity is confirmed as a false alarm.

While the invention has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed:

1. A method for mitigating insider threat to an organization, comprising:
retrieving, from a database stored on a computing system of the organization, Universal Serial Bus (USB) logs recording USB activities of users of the organization;
generating, based on the USB logs and using a machine learning (ML) module of an insider threat mitigation system, a trained ML model;
further retrieving, from the database and in response to generating the trained ML model, subsequent USB logs recording subsequent USB activities of the users;
analyzing, based on the trained ML model and using the ML module, the subsequent USB logs to detect an abnormal user activity; and
performing, in response to the detected abnormal user activity and using a revoke access module of the insider threat mitigation system, a mitigation task of the computer system.

2. The method of claim 1, wherein the mitigation task comprises:
revoking, in response to the detected abnormal user activity, USB access of a user account associated with the detected abnormal user activity.

3. The method of claim 1, further comprising:
retrieving, from the database, verified historical security incidence data records of the organization,
wherein generating the trained ML model is further based on the verified historical security incidence data records.

4. The method of claim 3, further comprising:
generating, based on the USB logs and the verified historical security incidence data records, a training data set,
wherein the trained ML model is generated by the ML module using an ML algorithm based on the training data set.

5. The method of claim 4, wherein generating the training data set comprises:
generating labeled training data of the training data set based on a portion of the USB logs that are correlated with the verified historical security incidence data records, and
generating unlabeled training data of the training data set based on a remaining portion of the USB logs that are not correlated with the verified historical security incidence data records,
wherein the ML algorithm comprises a semi-supervised machine learning algorithm.

6. The method of claim 5,
wherein the USB logs are generated by an Event Tracing for Windows (ETW) mechanism executing on the computer system, and
wherein the verified historical security incidence data records are generated by an Endpoint Detection and Response (EDR) tool executing on the computer system.

7. The method of claim 1, further comprising:
sending, using a reporting module of the insider threat mitigation system, a report of the detected abnormal user activity to an incident response team of the organization for further analysis.

8. An insider threat mitigation system, comprising:
a computer processor; and
memory storing instructions executable by the computer processor to perform insider threat mitigation, the instructions comprise:
a machine learning (ML) module configured to:
retrieve, from a database stored on a computing system of an organization, Universal Serial Bus (USB) logs recording USB activities of users of the organization;
generate, based on the USB logs, a trained ML model;
further retrieve, from the database and in response to generating the trained ML model, subsequent USB logs recording subsequent USB activities of the users; and
analyze, based on the trained ML model, the subsequent USB logs to detect an abnormal user activity; and
a revoke access module configured to:
perform, in response to the detected abnormal user activity and using, a mitigation task of the computer system.

9. The insider threat mitigation system of claim 8, wherein the mitigation task comprises:
revoking, in response to the detected abnormal user activity, USB access of a user account associated with the detected abnormal user activity.

10. The insider threat mitigation system of claim 8, the ML module further configured to:
retrieve, from the database, verified historical security incidence data records of the organization,
wherein generating the trained ML model is further based on the verified historical security incidence data records.

11. The insider threat mitigation system of claim 10, the ML module further configured to:
generate, based on the USB logs and the verified historical security incidence data records, a training data set,
wherein the trained ML model is generated by the ML module using an ML algorithm based on the training data set.

12. The insider threat mitigation system of claim 11, wherein generating the training data set comprises:
generating labeled training data of the training data set based on a portion of the USB logs that are correlated with the verified historical security incidence data records, and
generating unlabeled training data of the training data set based on a remaining portion of the USB logs that are not correlated with the verified historical security incidence data records,
wherein the ML algorithm comprises a semi-supervised machine learning algorithm.

13. The insider threat mitigation system of claim 12,
wherein the USB logs are generated by an Event Tracing for Windows (ETW) mechanism executing on the computer system, and
wherein the verified historical security incidence data records are generated by an Endpoint Detection and Response (EDR) tool executing on the computer system.

14. The insider threat mitigation system of claim 8, the instructions further comprise:
a reporting module configured to send a report of the detected abnormal user activity to an incident response team of the organization for further analysis.

15. A system, comprising:
a computing system of an organization; and
an insider threat mitigation system comprising:
a machine learning (ML) module configured to:
retrieve, from a database stored on a computing system of an organization, Universal Serial Bus (USB) logs recording USB activities of users of the organization;
generate, based on the USB logs, a trained ML model;
further retrieve, from the database and in response to generating the trained ML model, subsequent USB logs recording subsequent USB activities of the users; and
analyze, based on the trained ML model, the subsequent USB logs to detect an abnormal user activity; and
a revoke access module configured to:
perform, in response to the detected abnormal user activity and using, a mitigation task of the computer system.

16. The system of claim 16, wherein the mitigation task comprises:
revoking, in response to the detected abnormal user activity, USB access of a user account associated with the detected abnormal user activity.

17. The system of claim 16, the ML module further configured to:
retrieve, from the database, verified historical security incidence data records of the organization,
wherein generating the trained ML model is further based on the verified historical security incidence data records.

18. The system of claim 17, the ML module further configured to:
generate, based on the USB logs and the verified historical security incidence data records, a training data set,
wherein the trained ML model is generated by the ML module using an ML algorithm based on the training data set.

19. The system of claim 18, wherein generating the training data set comprises:
generating labeled training data of the training data set based on a portion of the USB logs that are correlated with the verified historical security incidence data records, and
generating unlabeled training data of the training data set based on a remaining portion of the USB logs that are not correlated with the verified historical security incidence data records,
wherein the ML algorithm comprises a semi-supervised machine learning algorithm.

20. The insider threat mitigation system of claim 19,
wherein the USB logs are generated by an Event Tracing for Windows (ETW) mechanism executing on the computer system, and
wherein the verified historical security incidence data records are generated by an Endpoint Detection and Response (EDR) tool executing on the computer system.
